(19) United States
(12) Patent Application Publication
(10) Pub. No.: US 2025/0005599 A1
(43) Pub. Date: Jan. 2, 2025

(54) Method for performance management, a circuitry and a method for monitoring performance management

(71) Applicants: Krishna Kumar GANESAN, Vancouver, WA (US); Vincent J. ZIMMER, Issaquah, WA (US); Ankit SINHA, Aloha, OR (US); Ram BHATTARAI, North Plains, OR (US)

(72) Inventors: Krishna Kumar GANESAN, Vancouver, WA (US); Vincent J. ZIMMER, Issaquah, WA (US); Ankit SINHA, Aloha, OR (US); Ram BHATTARAI, North Plains, OR (US)

(21) Appl. No.: 18/830,622

(22) Filed: Sep. 11, 2024

(51) Int. Cl. G06Q 30/018; G06F 21/33

(52) U.S. Cl. CPC G06Q 30/018; G06F 21/33

(57) ABSTRACT

A method for performance management is provided. The method includes receiving information to determine a location of a host platform. The method further comprises receiving information on a compliance policy comprising a list of countries and a list of semiconductor-tor devices. Additionally, the method comprises throttling a performance of a semiconductor-tor device associated with the host platform based on the information on the compliance policy if the semiconductor device is within the list of semiconductor devices and if the location of the host platform matches with a country within the list of the countries.

### BACKGROUND

The demand for high-performance computing semiconductor devices has been increasing to support various applications such as AI inference, data processing, media, and gaming. To meet diverse market demands and comply with regulations, manufacturers often use stock keeping units (SKUs) to manage products with different hardware designs for various markets. However, for international business operation, managing SKUs may become complex due to the need for adaptation according to regulations in different countries. Different market may have unique requirements for production specifications. Also, each country may have distinct regulatory frameworks for exports and imports. Therefore, if regulations change, vendors may need to establish different production lines to comply with the new requirements, and SKUs may need to be updated accordingly. This could introduce an additional layer of complexity to product inventory management. Therefore, there may be a growing demand for an improved way to manage semiconductor devices efficiently across global markets.

### BRIEF DESCRIPTION OF THE FIGURES

Some examples of apparatuses and/or methods will be described in the following by way of example only, and with reference to the accompanying figures, in which

FIG. 1 illustrates an exemplary flowchart of a method for performance management;

FIG. 1a illustrates an exemplary flowchart of the method being executed by a code or firmware for performance management;

FIG. 2 illustrates an exemplary flowchart of a method for monitoring performance management;

FIG. 3 illustrates an example of a circuit for performance management;

FIG. 4 illustrates an example of a circuitry for performance management; and

FIG. 5 illustrates an example of a computer system for performance management.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

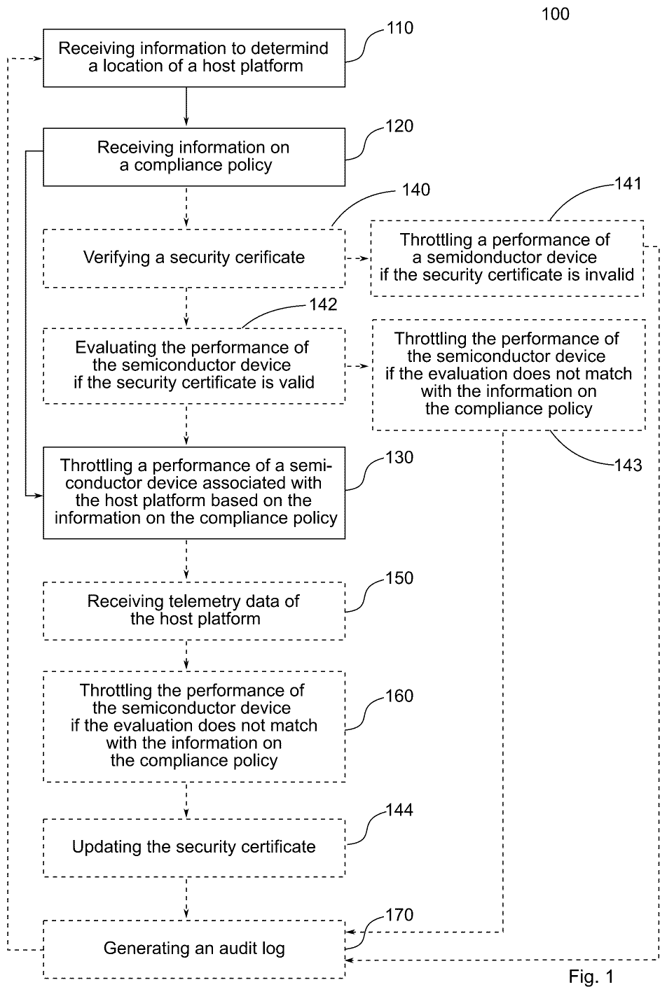

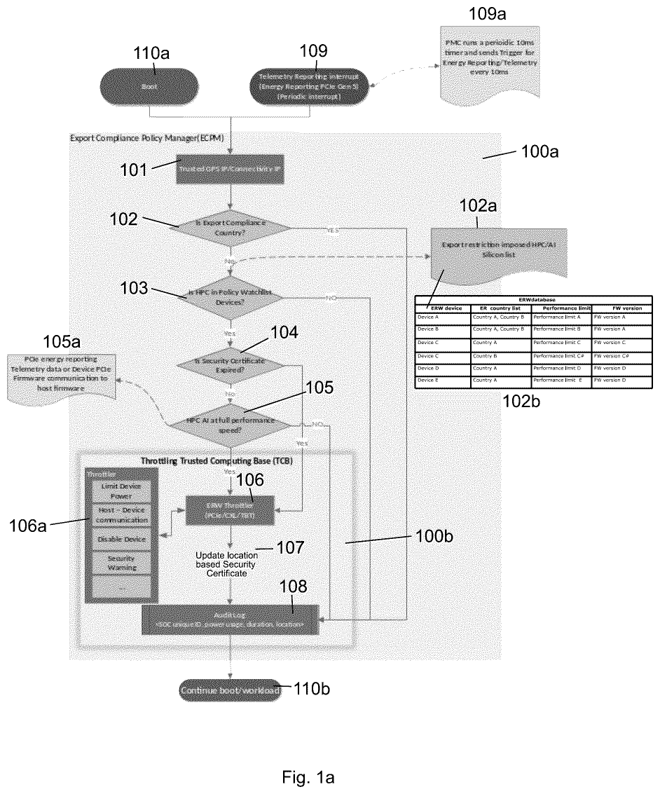

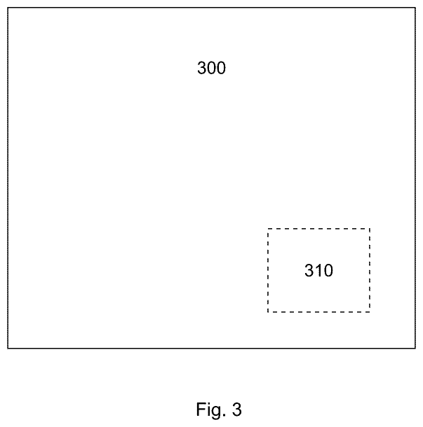

FIG. 1 illustrates a flowchart of an example of a method 100 for performance management. The method 100 comprises receiving 110 information to determine a location of a host platform. The host platform may be an environment hosting execution of the method 100, for example, using a circuit for performance management as illustrated in FIG. 3. For example, the circuit for performance management may be connected to or implemented in a motherboard of the host platform. Further, the method 100 comprises receiving 120 information on a compliance policy. The compliance policy may comprise a list of countries (a country list) and a list of semiconductor devices (a device list). The compliance policy may be an export compliance policy which provides a set of regulations applied to a product (e.g. a semiconductor device), technology, or a service exported to other countries. The information on the compliance policy may be mapped to the compliance policy. If the compliance policy changes, the information on the compliance policy may be updated accordingly to reflect this change. According to the compliance policy, special settings or performance restrictions may apply to the semiconductor device, depending on the country the semiconductor device is operated in. The method 100 further comprises throttling 130 a performance of a semiconductor device associated with the host platform based on the information on the compliance policy if the semiconductor device is within the list of semiconductor devices and if the location of the host platform matches with a country within the list of the countries. A semiconductor device may be any device that is required to operate at different performance levels in different countries. These performance levels may be governed by the compliance policy, which may be an export compliance policy defined by a manufacturer of the device. Alternatively, the compliance policy may also be defined by the local authorities of a country the semiconductor device is operated in. The semiconductor device may be executed within the environment of the host platform. For example, the semiconductor device may be a system on chip (SoC) or an integrated circuit (IC), which may host the execution of the method 100. The semiconductor device associated with the host platform may refer that the semiconductor device may interact with or be (logically or physically) connected to the host platform by exchanging signals or data. For instance, the information on the compliance policy may be provided such that the semiconductor device (e.g. name or identifier of the semiconductor device) and the location of the host platform (e.g. country) can be searched in or compared to the device list and the country list, respectively.

The (export) compliance policy may impact businesses operating internationally, as it may require the production of different product variations tailored to specific target markets (e.g. countries). Vendors may often use SKUs to manage these variations. SKU can be understood as a unique identifier assigned to each product variant. In general, SKUs help track and manage inventory, distinguishing between different variations. However, there are some challenges to comply with the export compliance policy.

For instance, a manufacturer may need to produce customized versions of a semiconductor device with varying specifications to comply with export compliance policies, such as different performance levels for different markets. This often results in multiple SKUs within a single semiconductor family, each tailored to a specific market. The need to create these variations may require additional costs and time to the production process and inventory management. Moreover, if export compliance policies change, existing products may become unsellable or undesirable in their original target markets. For example, a semiconductor device with reduced performance, designed to meet specific export requirements, might not be viable in other markets due to its performance limitations. Additionally, if regulations are relaxed, the low-performance variants may no longer be desirable, leading to wasted inventory and further financial losses.

The method 100 may provide a way to manage performance of the semiconductor device in accordance with the information on the compliance policy by throttling 130 the performance of the semiconductor device based on the location of the host platform if the semiconductor device is on the device list without designing or producing semiconductor devices tailored to target markets. In other words, the method 100 may enable a way to produce a single semiconductor device and the performance of the semiconductor device may be managed based on the location of the host platform. Therefore, using the method 100, a manufacturer may reduce operational costs and time associated with multiple production lines, storage, and logistics by producing variations of semiconductor devices tailored to specific markets in compliance with regulatory policies.

For instance, the information to determine the location of the host platform may be provided such that the country the host platform is operated in can be identified (e.g. the country where the host platform is located). The information may, for example, be gathered by the host platform itself. In this event, the information to determine the location may, e.g., be network location information (e.g. an IP geolocation or a Wi-Fi location), a Global Navigation Satellite System (GNSS) positioning signal such as a Global Positioning System (GPS) signal, a network latency or log entries of the host platform. Alternatively, the information to determine the location of the host platform may be generated by an external entity and/or queried from a database.

For example, the semiconductor device may be associated with the host platform such that the semiconductor device may be connected to the host platform via electrical pathway, trace, or slot. The semiconductor device can be controlled by the host platform and, for example, reside on a PCI or PCIe extension card connected to a motherboard of a computing system.

In such case, the location of the semiconductor device may be identical to the location of the host platform, or vice versa. The semiconductor device may optionally comprise a GNSS tracker (e.g. a chiplet for GPS), which can receive a signal including timing or position data from a satellite or signals from multiple satellites to determine the position of the semiconductor device. Then, the position may be mapped to the location (country) of the semiconductor device. If the semiconductor device is connected to the host platform as described above, the received signal may be used as the information to determine the location of the host platform.

The information to determine the location of the host platform may be a combination of data, signals, or information provided by multiple resources as mentioned above. For example, detected location data may be provided by three different sources (e.g. GPS signal, Wi-Fi positioning, and IP geolocation). In such a case, the location of the host platform may be determined if at least two of the three sources provide matching information (e.g. the same country). This may improve the reliability and accuracy of the information to determine the location of the host platform. If the location of the host platform might not be determined, the performance of the semiconductor device may be throttled or disabled.

The information on the compliance policy may optionally comprise a list of predetermined performance thresholds associated with the semiconductor devices (e.g. a performance threshold list). The predetermined performance thresholds may be allowable (e.g. maximum) performance limits of the semiconductor devices on the device list for each country on the country list. For example, a device A may be on the device list, a country A may be on the country list, and a performance limit A on the performance threshold list may be associated with (defined for) device A in country A. In other words, it may be considered that device A may be operated at performance limit A or below in country A (e.g. the location of the host platform) according to the information on the compliance policy. Different performance thresholds may be associated with the same device, depending on the country where the host platform is located. Additionally, for throttling 130 the performance of the semiconductor device, a 5%, 10%, or 15% lower predetermined performance threshold may be applied to prevent violation of the compliance policy.

Throttling 130 the performance of the semiconductor device may be performed by various methods or means since various parameters may be related to the performance of the semiconductor device. For example, the parameters may comprise clock speed, number of cores, memory bandwidth, or power supply of the semiconductor device or an interface which associates (couples, interfaces) the semiconductor device with the host platform. The interface may provide a communication pathway between the host platform and the semiconductor device (or between components of the host platform), which enables data or signal transmission between the host platform and the semiconductor device and power delivery to the semiconductor device. These settings (values) of one or more of these parameters may be reduced or adjusted for throttling 130 the performance of the semiconductor device in accordance with the information on the compliance policy. For example, for throttling 130 the performance of the semiconductor device, any one or more of the above-mentioned parameters may be adjusted or reduced to throttle the performance of device A to performance Limit A or below in country A.

Throttling 130 of the performance of the semiconductor device may optionally comprise at least one of limiting slot power of the semiconductor device, limiting an interface speed of the semiconductor device, or disabling the semiconductor device.

Limiting the slot power of the semiconductor device may be performed by reducing power supply to the slot of the interface to which the semiconductor device is connected. The reduced power supply may be based on the information on the compliance policy (e.g. predetermined performance threshold associated with/defined for the semiconductor device). In general, the performance of a semiconductor device may be related to its power (energy) consumption. As the performance increases, so does the energy consumption, as more power may be required to execute complex calculations and handle data-intensive tasks at higher speeds. Therefore, limiting the slot power may throttle the performance of the semiconductor device.

Limiting the interface speed may be performed by reducing the data transfer rate or bandwidth of the interface. This may decrease the rate at which data is exchanged between the semiconductor device and the host platform, which can throttle the performance of the semiconductor device. Similar to limiting the slot power of the semiconductor device, the interface speed may be reduced in accordance with the information on the compliance policy so that the performance of the semiconductor device can be throttled to its performance threshold or below.

Disabling the semiconductor device may involve cutting off communication between the semiconductor device and the host platform or power supplied to the semiconductor device, rendering the semiconductor device unusable in connection with the host platform. This may prevent the semiconductor device from functioning.

For example, the interface provided by the host platform to attach or control the semiconductor device may be any one of peripheral component interconnect express (PCIe), a compute express link (CXL), or a thunderbolt technology (TBT) device. PCIe, CXL, and TBT are high-speed interface technologies used in computing, designed to facilitate rapid data transfer between components (e.g. the semiconductor device) within a host platform or between the semiconductor device and the host platform. As the interface may supply power to the semiconductor device, limiting the slot power for PCIe, CXL, or TBT may throttle the performance of the semiconductor device, leading to reduced operational efficiency as described above. Similarly, restricting the speed of these interfaces may also throttle the performance, as it decreases the available bandwidth for data transfer between the semiconductor device and the host platform. This reduction in bandwidth may affect the device's ability to communicate efficiently, leading to overall diminished performance.

Additionally or alternatively, floating-point operations per second (FLOPS) of the semiconductor device may be reduced for throttling 130 the performance of the semiconductor device. FLOPS is related to an ability to perform floating-point calculations, which can be used for computing, graphics rendering, machine learning, AI, simulation, or any other data-intensive ap-plications. The reduction in FLOPS of the semiconductor device may throttle the performance of the semiconductor device. Similarly, the memory bandwidth of the semiconductor device may be reduced for throttling 130 the performance of the semiconductor device. Furthermore, AI-specific features embedded in the semiconductor device may be restricted for throttling 130. This is a non-exhaustive list of examples of performance throttling based on the information on the compliance policy. Any type of performance restriction (e.g., throttling) may be applied to the semiconductor device on the device list associated with the host platform located in a country listed in the information on the compliance policy.

The method 100 may optionally further comprise verifying 140 a security certificate of the semiconductor device associated with the host platform. For instance, the security certificate can be understood as a validation that the semiconductor device meets certain security standards or criteria, ensuring that the semiconductor device can be trusted. It may comprise an identifier of the semiconductor device, which may be used to compare the semiconductor device to the device list. The security certificate may comprise a validity period or expiration date, thereby the security certificate may need to be re-evaluated to maintain the certification. Further, the security certificate may comprise information related to the information on the compliance policy or to the compliance policy. For instance, the security certificate may be considered valid, if it provides an identifier of the semiconductor device and is not expired. The verification of the security certificate may be used as an additional safety measure to comply with the compliance policy.

The method 100 may optionally comprise throttling 141 the performance of the semiconductor device if the security certificate is invalid. The security certificate may become invalid due to revocation, expiration without renewal, adherence to outdated standards, or because it was falsely or fraudulently obtained. The security certificate may be considered invalid, if it is expired or information comprised in the security certificate is revoked (e.g. modified identifier of the semiconductor device or unauthorized extension of the expiration period). In such a case, throttling 141 the performance of the semiconductor device with an invalid security certificate may reduce a risk of violating the compliance policy.

In some examples, the method 100 may optionally comprise evaluating 142 the performance of the semiconductor device if the security certificate is valid. The performance of the semiconductor device may be evaluated by analyzing any of the parameters described above (e.g. power supply to the semiconductor device). The method 100 may further comprise throttling the performance of the semiconductor device if the evaluation does not match with the information on the compliance policy 143. The mismatch may be higher power consumption, voltage supply, or clock speed than expectation based on the information on the compliance policy. For instance, in order to operate or execute Device A in Country C at Performance threshold A or below according to the information on the compliance policy, Power A or lower may be supplied to the semiconductor device. However, if the power consumption of Device A is higher than expected power consumption based on Power A (or lower), Device A may be throttled according to the method 100.

Optionally, the method 100 may comprise receiving telemetry data 170 of the host platform. The telemetry data can be understood as information collected from the host platform to monitor its performance and performances of associated components (e.g. the semiconductor device). The information may comprise performance metrics (e.g. usage reports of components, usage report of the semiconductor device, memory usage, network traffic, or system load), health metrics (e.g. temperature of the semiconductor device or other components), resource utilization, application and service monitoring, or long-term trends and analytics.

For example, the telemetry data may comprise an energy report. The energy report can be understood as information or data related to power consumption, thermal performance, energy efficiency, or energy consumption of the host platform or each element/component (e.g. a semiconductor) associated with the host platform.

The method 100 may optionally comprise throttling 160 the performance of the semiconductor device if the telemetry data does not match with the information on the compliance policy. For instance, an energy consumption (e.g. power consumption) of the semiconductor device is higher than an expectation (e.g. expected power consumption) based on the information on compliance policy. As described above, the energy consumption of the semiconductor device may be related to the performance of the semiconductor device. Therefore, the energy consumption of the semiconductor device may be used as an indicator to check if throttling the performance of the semiconductor device 160 is performed in accordance with the information on the compliance policy. Other metrics comprised in the telemetry data related to the performance of the semiconductor device may be used to check whether it matches with the information on the compliance policy (e.g. the predetermined performance threshold) for throttling the performance of the semiconductor device 160.

The telemetry data may provide real-time information related to the performance of the semiconductor device, which may trigger an automated response, e.g. throttling 130 the performance of the semiconductor device. Therefore, the telemetry data may contribute to an enhanced performance management by enabling the monitoring of the performance of the semiconductor device.

The method 100 may optionally comprise updating 144 the security certificate of the semiconductor device associated with the host platform. As described above, the security certificate may comprise a period of validity or expiration date. Therefore, the security certificate may need to be updated or renewed before the expiration. Updating 144 the security certificate may enhance security and ensure compliance with updated regulatory requirement (e.g. the information on the compliance policy).

Optionally, the method 100 may comprise generating 170 an audit log. The audit log may comprise at least one of the location of the host platform or a power usage or an identifier of the semiconductor device associated with the host platform. The audit log may be generated as a tuple of the location of the host platform (e.g. country) and the power consumption of the semiconductor device. The audit log may further comprise a detailed record of activities and events that occur on the host platform. It may serve functions in monitoring, security, and compliance, providing transparency and accountability for any actions taken on the host platform. In the context of a compliance audit, the audit log can be utilized to verify that actions performed on the host platform align with the information on the compliance policy. By reviewing the audit log related to the location information of the host platform and the performance of semiconductor device, an auditor may monitor and ensure that the performance of the semiconductor device is managed in accordance with the information on the compliance policy.

Therefore, the method 100 may provide a way to manage the performance of the semiconductor device. By using the received information to determine location of the host platform, the method 100 may control the performance of the semiconductor device associated with the host platform. The method 100 might not require a need for a separate production line to manufacture specific semiconductor devices for export to countries in the country list of the information on the compliance policy, thereby reducing the cost of setting up another semiconductor manufacturing line. When semiconductor devices tailored to specific countries often might not be resold to other markets due to performance restriction by the information on the compliance policy. The method 100 may offer a way to produce a single version of the semiconductor device that can be sold globally. Hence, when location dependent performance restrictions are lifted, the same semiconductor device may still be used without replacement, ensuring flexibility and adaptability of the performance management of the semiconductor device according to any updates to the compliance policy. Furthermore, the method 100 may improve inventory management by reducing the complexity of maintaining multiple product versions, which can streamline logistics and reduce overhead costs.

The method 100 may be executed by code or firmware embedded in the host platform or in the semiconductor device. For instance, the method 100 may be executed during boot flow or runtime of one of the host platform or the semiconductor device. During runtime, the method 100 may be executed regularly, e.g. predetermined time interval, to monitor performance management of the semiconductor device and to throttle the performance of the semiconductor device according to the information on the compliance policy. An example of the firmware related to the method 100 will be further detailed in FIG. 1a.

FIG. 1a illustrates an exemplary flowchart of the method 100 being executed by an embedded firmware of the host platform or the semiconductor.

For example, the semiconductor device may be associated with the host platform via the interface (e.g. PCIe, CXL, or TBT) as described above. The host platform may communicate with the semiconductor device via the interface.

The embedded firmware may comprise an export compliance policy manager (ECPM) 100a. In general, a firmware may include different firmware modules which handle specific tasks or control hardware functions. The ECPM 100a may comprise a throttling trusted computing base (TCB) module 100b (throttling TCB module 100b), which may be used for managing or controlling the performance of the semiconductor device. In this context, the method 100 may be executed or handled by the ECPM 100a.

During boot flow 110a of the host platform, the embedded firmware may trigger an execution of the ECPM 100a. The ECPM 100a may receive at 101 a trusted GPS IP or connectivity IP, which can be used to determine the location (e.g. country) of the host platform. The trusted GPS IP or connectivity IP is an example for information to determine the location of a host platform. Further, the ECPM 100a may receive or use an export restriction watchlist (ERW) database 102b stored in the ECPM 100a. For instance, in this context, the ERW database 120b can be understood as the information on the compliance policy as described above. The ERW database 102b may comprise an ERW device list listing semiconductor devices, an ERW country list listing countries, and a performance limit list listing performance limits. The ERW database 102b may further comprise a firmware version list, which may be a list of firmware versions associated with the semiconductor devices in the ERW device list for each country in the ERW country list. For instance, the ERW device list may be referred to as an ER imposed high-performance computing or silicon list 102a. The ERW database 102b is an example for the information on the compliance policy described above. Similarly, the ERW device list is an example for the device list, the ERW country list is an example for the country list and the performance limit list is an example for the predetermined performance thresholds described above.

According to the method 100, throttling 130 the performance of the semiconductor device associated with the host platform based on the information on the compliance policy is performed if the semiconductor device is within the list of semiconductor devices and if the location of the host platform matches with a country within the list of the countries. Accordingly, the ECPM 100a may trigger at 102 a comparison of the determined location of the host platform to the ERW country list (e.g. location comparison event) and at 103 a comparison of the semiconductor device to the ERW device list (e.g. device comparison event).

If the location of the host platform is not in the ERW country list, the throttling TCB module 100b may be activated and trigger at 108 the recording of an audit log (audit log event) analogously to what is described above for generating 170 the audit log. The audit log may comprise an identifier of the semiconductor device, a power usage of the semiconductor device, the interface, or the host platform, the location of the host platform, or a duration (or any time span) related to usage of the semiconductor device, the interface, or the host platform. For example, these data in the audit log may be recorded in a public blockchain to improve transparency and security for auditing. Then, the boot flow may continue at 110b without further action related to the ECPM 100a. In other words, the performance of the semiconductor device might not be restricted (throttled).

If the location of the host platform is on the ERW country list, a device comparison may follow at 103. If the semiconductor device is not on the ERW device list, as described above, the throttling TCB module 100b may triggers the audit log at 108 and the boot flow may continue at 110b as described above.

If the semiconductor device is on the ERW device list, the EPCM may trigger at 104 verification of the security certificate of the semiconductor device similar to verifying 140 the security certificate described above.

If the security certificate of the semiconductor device is valid (e.g. not expired), the EPCM 100a may trigger at 105 evaluation of the performance of the semiconductor device (evaluation event) similar to evaluating 142 the performance of the semiconductor device described above. For example, this may be enabled by a firmware of the semiconductor device. The firmware may evaluate the performance of the semiconductor device using various performance metrics 105a. The performance metrics 105a may include power telemetry data from a slot of the interface to which the semiconductor is connected (e.g. PCIe energy reporting telemetry data), an estimation based on configuration registers (e.g. device identifier, vendor of the device identifier) of the semiconductor device, or communication with device configuration register. The configuration registers can be understood as holding settings or control information that determine the behavior and operation of the interface, which may affect the performance of the semiconductor device. The configuration register of the interface may comprise information or settings of the semiconductor device, which may be connected to the interface via the slot. The configuration registers may be comprised in a configuration space of the interface, which may enable an access to the configuration registers. For example, the communication with device configuration register can be understood as communication between the firmware of the interface (e.g. PCIe firmware) and a host firmware (e.g. the embedded firmware of the host platform). The host firmware may read information or settings in the configurations (the configuration registers) of the interface to gather information about the capabilities or status of the interface via the configuration space, as described above, which may comprise the information of the settings of the semiconductor device. Then, the performance of the semiconductor device may be compared to the ERW database 102b using any one or more of the performance metrics 105a to check whether the performance of the semiconductor device is operated at or lower than the performance threshold associated with the semiconductor device for the location of the host platform (e.g. country) in the ERW database 102b similar to what is described above for evaluating 142 the performance of the semiconductor device and throttling 143 the performance of the semiconductor device if the evaluation does not match with the information on the compliance policy. If the comparison indicates that the performance of the semiconductor device does not exceed the allowable performance limit associated with the semiconductor device in the ERW database 102b, the throttling TCB module 100b may triggers the audit log at 108 and the boot flow may continue at 110b as described above.

If the performance of the semiconductor device is higher than the allowed performance limit, the throttling TCB module 100b may triggers at 106 throttling the performance of the semiconductor device (throttling event) in accordance with the ERW database 102b. As described above, various parameters or settings (e.g. throttler at 106a). may be reduced or adjusted in order to reduce, restrict, or disable the performance of the semiconductor device. The throttling event 106 may utilize various throttling actions 107, e.g. limiting power supply to the interface or the slot of the interface (connected to the semiconductor device), disabling communication between the interface and the semiconductor device, disabling the semiconductor device, sending warning, limiting the interface speed, or modifying the configuration registers of the semiconductor device (e.g. host communication to the semiconductor device via the configuration space) to limit its speed. As described above, any types of throttling actions may be chosen to throttle the performance of the semiconductor device. Then, the throttling TCB module 100b may further triggers at 107 updating the security certificate (certificate update event). As described above for updating 144 the security certificate of the semiconductor device, the certificate update event 107 may update the validation period of the security certificate, which may be based on the information on the compliance policy period. As described above, the throttling TCB module 100b may trigger the audit log at 108 and the boot flow may continue at 110b.

During runtime of the host platform, the performance of the semiconductor device may be monitored and the ECPM 100a may be invoked or triggered to control (throttle) the performance of the semiconductor device in accordance with the ERW database as described above.

For example, the interface (e.g. PCIe) may comprise an energy reporting register, which can measure energy consumed by the interface and accumulate the energy consumption over time. The energy consumption may include the energy consumption of the semiconductor connected to the interface. The host platform may comprise a power management controller (PMC), which can oversee the overall power management of the host platform. For instance, the PMC may read information or data from the energy reporting register to monitor the power usage of the interface or any individual components (e.g. the semiconductor device) connected to the host platform, which can be used to check whether the power consumption of the semiconductor device is higher than expected power consumption of the semiconductor device based on its allowable performance limit according to the ERW database 102b similar to what is described above. The PMC may run periodically (e.g. predetermined time interval) and report the telemetry data of the interface of the semiconductor device periodically (e.g. predetermined time interval) to the semiconductor device or the host platform at 109a. For instance, if the telemetry data indicates that the power consumption of the semiconductor device is higher than expected power consumption according to its allowable performance limit (e.g. the ERW database) as described above, the PMC may send a trigger for telemetry reporting interrupt 109 to the semiconductor device or the host platform. For instance, a firmware interrupt handler of the semiconductor device may invoke the ECPM 100a to throttle the performance of the semiconductor device. This is an example of receiving 150 telemetry data of the host platform described above. The firmware interrupt handler can be understood as a piece of low-level code embedded in the firmware of the semiconductor device, which may handle or respond to an interrupt (e.g. the telemetry interrupt 109) requiring immediate attention. Alternatively, the PMC may send a trigger for the telemetry reporting interrupt 109 regularly (e.g. predefined condition or time interval) in order to trigger the ECPM 100a regularly.

The exemplary flowchart of FIG. 1a serves as a visual representation of the embedded firmware (e.g., the ECPM)'s logical flow in connection with the method 100. As described above, the ECPM 100a may provide a way to throttle and monitor the performance of the semiconductor device in accordance with the information on the compliance policy (e.g. the ERW database) to comply with the compliance policy.

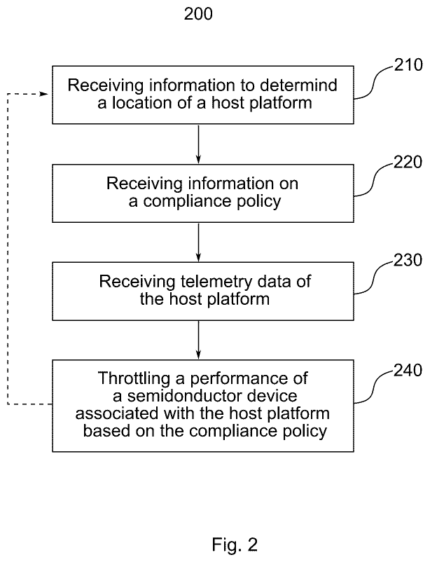

FIG. 2 illustrates a flowchart of a method 200 for monitoring performance management. The method 200 comprises receiving 210 information to determine a location of a host platform. The method 200 further comprises receiving 220 information on a compliance policy comprising a list of countries (a country list) and a list of semiconductor devices (a device list). The method 200 further comprises receiving 230 telemetry data of the host platform. Additionally, the method 200 comprises throttling 240 a performance of the semiconductor device if the location of the host platform matches with a country within the list of countries and if the telemetry data does not match with an expectation based on the information on the compliance policy. The compliance policy, the information on the compliance policy, the host platform, the semiconductor device, and the telemetry data are as described above for the method 100. Additionally, throttling may be performed analogously to what is described above for the method 100. The expectation may be expected performance of the semiconductor device according to the information on the compliance policy. The telemetry data may be used to assess the expected performance of the semiconductor device analogously to what is described above for the method 100.

The method 200 may provide a way to monitor and control any non-compliance activities of the semiconductor device based on the determined location of the host platform by using the telemetry data of the host platform. The method 200 may be executed regularly (e.g. predetermined time interval). For instance, the method 200 may be executed during boot flow and the received information to determine a location of the host platform may initially indicates that the host platform is not located in a country on the country list. Then, the semiconductor device associated with the host platform may be used without its performance restriction (e.g. throttling). During runtime of the host platform, if the location of the host platform changes and the received information to determine a location of the host platform matches with a country on the country list, throttling 240 can be performed. This may offer an additional security for the performance management of the semiconductor device to comply with the information on the compliance policy.

More details and aspects are mentioned in connection with the embodiments described above or below. The example shown in FIG. 2 may comprise one or more optional additional features corresponding to one or more aspects mentioned in connection with the proposed concept or one or more examples described above (e.g. FIGS. 1 and 1a) or below (e.g. FIGS. 3-5).

The information to determine the location of the host platform may be provided such that the location of the host platform can be converted and identified as a country (e.g. the country where the host platform is located), which can be compared to the country list. The received information may, e.g., be network location information (e.g. an IP geolocation or a Wi-Fi location), a GNSS positioning signal such as a GPS signal, a network latency analysis or a log analysis of the host platform. Analogously to what is described above for the method 100, the location of the host platform may be used as the location of the semiconductor device, or vice versa.

The information on the compliance policy may optionally comprise a list of predetermined performance thresholds associated with the semiconductor devices (e.g. a performance threshold list) analogously to what is described above for the method 100. The predetermined performance thresholds may be allowable (e.g. maximum) performance limits of the semiconductor devices on the device list for each country on the country list.

Analogously to what is described above for the method 100, throttling 240 may be performed using various methods or means. Therefore, different parameters related to the performance of the semiconductor may be used for throttling 240 as well. For instance, the telemetry data may comprise a usage report of the semiconductor device, which can indicate metrics on the semiconductor device's resources related to its performance (e.g. core count, clock speed, or memory). The mismatch between the telemetry data and the expectation may be higher resource usage than the predetermined performance threshold associated with the semiconductor device based on the information on the compliance policy. Then throttling 240 may be performed accordingly by reducing the number of cores being used, the clock speed, or the memory bandwidth of the semiconductor device.

For example, the telemetry data may optionally comprise an energy report of the host platform. Analogously to what is described above for the method 100, the energy report may comprise energy consumption (power consumption) of components associated with the host platform, e.g. the semiconductor device.

For example, the mismatch between the telemetry data and the expectation may optionally be that an energy consumption of the semiconductor device is higher than the expectation based on the information on the compliance policy. Since the performance of the semiconductor device can be directly related to the energy (power) consumption of the semiconductor device as described in FIG. 1, higher energy consumption of the semiconductor device may be considered as the semiconductor device is operated over the allowable performance limit. Then, throttling 240 may be performed by reducing power supply to the semiconductor device analogously to what is described above for the method 100.

Analogously to what is described for the method 100 (e.g. FIGS. 1 and 1a), the method 200 may be executed by a code or a firmware embedded in the host platform or in the semiconductor device. For instance, the method 200 may be executed during runtime of one of the host platform or the semiconductor device. During runtime, the method 200 may be executed regularly, e.g. predetermined time interval, to monitor performance management of the semiconductor device and to throttle the performance of the semiconductor device according to the information on the compliance policy.

Therefore, the method 200 may provide a way to monitor performance management by monitoring the telemetry data of the host platform. It may enable the early detection of irregularities or non-compliance and allow for immediate intervention, e.g. throttling 240 the performance of the semiconductor device, in accordance with the compliance policy.

FIG. 3 illustrates an example of a circuit 300 for performance management. The circuit 300 is configured to receive information to determine a location of the circuit 300. The circuit 300 is further configured to receive information on a compliance policy comprising a list of countries (a country list) and a list of circuits (a circuit list). Additionally, the circuit 300 is further configured to throttle a performance of the circuit 300 based on the information on the compliance policy if the circuit is within the list of circuits and if the location of the circuit matches with a country within the list of countries. The compliance policy and the information on the compliance policy are as described above for the methods 100, 200. Additionally, throttling may be performed analogously to what is described above for the methods 100, 200.

The circuit 300 may provide a way for self-performance-controlling depending on the determined location in accordance with the information on the compliance policy. For instance, the circuit 300 may be on the circuit list and used in the country (e.g. the location of the circuit 300). In such a case, the performance of the circuit 300 may be self-controlled based on its determined location to throttle the performance of the circuit 300. Analogously to what is described above for the methods 100, 200, the circuit 300 may trigger a power supply reduction to the circuit 300 or a core clock speed reduction to the circuit 300 or a voltage reduction of the circuit 300 or trigger deactivation of cores in order to throttle the performance of the performance of the circuit 300.

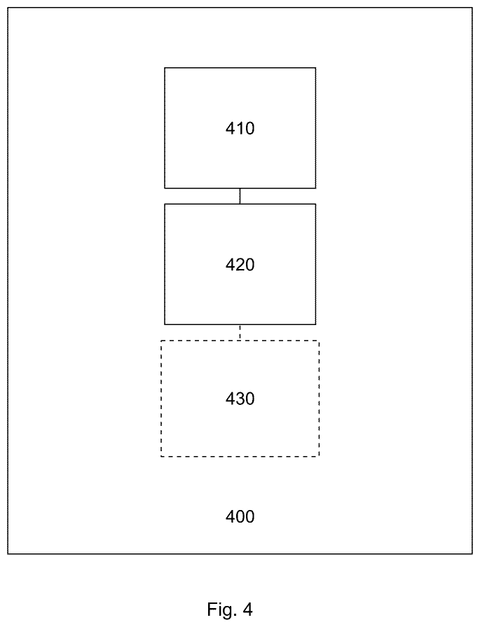

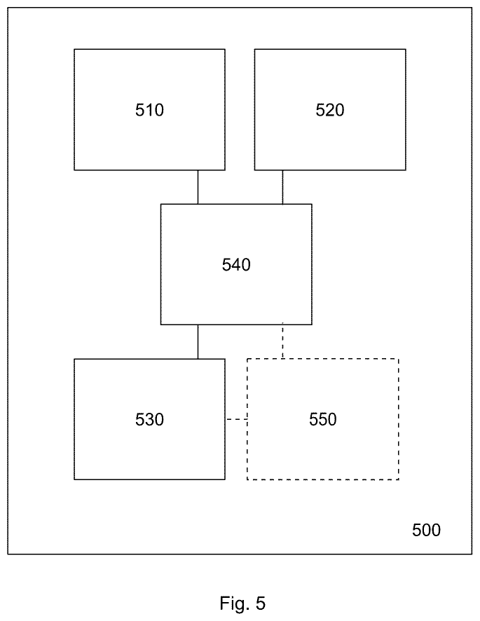

More details and aspects are mentioned in connection with the embodiments described above or below. The example shown in FIG. 3 may comprise one or more optional additional features corresponding to one or more aspects mentioned in connection with the proposed concept or one or more examples described above (e.g. FIGS. 1-2) or below (e.g. FIGS. 4-5).

The information to determine the location of the circuit 300 may be as described above for the methods 100, 200. Additionally, the information on the compliance policy may further comprise a list of predetermined performance thresholds associated with the circuits in the circuit list for each country in the country list analogously to what is described above for the methods 100, 200.

For example, the circuit 300 may optionally comprise a device 310 to receive information on the location of the circuit 300. The device may be a GNSS tracker analogously to what is described above for the methods 100, 200. The circuit 300 may receive the information of to determine the location of the circuit 300 regularly (e.g. predetermined time interval). The device 310 comprised in the circuit 300 may further improve the reliability of the determined location of the circuit 300.

Analogously to what is described above for the methods 100, 200, the circuit 300 may further be configured to assess (e.g. evaluate, estimate, measure, or receive) its power consumption and throttle the performance of the circuit 300 to monitor and control the performance of the circuit 300 in accordance with the information on the compliance policy.

Therefore, the circuit 300 may be directly used in various countries comprising countries in the country list in the information on the compliance policy by using the performance throttling. It may reduce the cost associated with designing, testing, and certifying multiple versions of the circuit 300 to meet regulatory requirements for different market.

FIG. 4 illustrates an example of a circuitry 400 for performance management. The circuitry 400 comprises a storage medium 410 to store information on a compliance policy. The information on the compliance policy comprises a list of countries (a country list) and a list of semiconductor devices (a device list). The circuitry 400 further comprises a processor 420 configured to receive information to determine a location of the circuitry 400 and to throttle a performance of a semiconductor device 430 associated with the circuitry 400 based on the information on the compliance policy if the (associated) semiconductor device matches with a semiconductor device within the list of semiconductor devices and if the location of the circuitry 400 matches with a country within the list of countries. The compliance policy, the information on the compliance policy and the information on the location of the host platform are as described above for the methods 100, 200. Additionally, throttling may be performed analogously to what is described above for the methods 100, 200.

The circuitry 400 may provide a way to manage and control the performance of the associated semiconductor device according to the information on the compliance policy based on the location (country) of the circuitry 400.

More details and aspects are mentioned in connection with the embodiments described above or below. The example shown in FIG. 4 may comprise one or more optional additional features corresponding to one or more aspects mentioned in connection with the proposed concept or one or more examples described above (e.g. FIGS. 1-3) or below (e.g. FIG. 5).

Within the circuitry 400, the storage medium 410 may be connected to the processor 420 via electrical pathways, traces, or an interface, which may allow them to communicate with each other (e.g. signal or data transmission). The semiconductor device associated with the circuitry 400 may be associated such that the semiconductor device may be connected to the processor as described above for the storage medium 410. The interface is as described above for the methods 100, 200.

The information on the compliance policy is as described above for the methods 100, 200. For example, the information on the compliance policy may be stored in the storage medium 410 such that the semiconductor device (e.g. name or identifier of the semiconductor device) and the location of the host platform (e.g. country) can be searched in or compared to the device list and the country list. The processor 420 may identify the location (e.g. a country) of the circuitry 400 based on the information to determine the location of the circuitry 400 and scan the semiconductor device to identify the name (e.g. a reference number, a model number or an identifier) of the semiconductor device via the interface if the semiconductor device is associated with the processor 420 as described above. If the location of the circuitry 400 and the name of the semiconductor device match with a country on the country list and a semiconductor device on the device list, respectively, the processor 420 may send a signal, data, or information to throttle the performance of the semiconductor device analogously to what is described for the methods 100, 200. For instance, the signal, the data, or the information may be a reduced number of activated cores, reduced fan speed, reduced voltage, or reduced clock speed of the semiconductor device or reduced supplied power to the semiconductor device compared to its maximum design capacity or disabling the semiconductor device. Analogously to what is described for the methods 100, 200, various parameters may be related to the performance of the semiconductor device. Any one or more of the parameters may be adjusted to throttle the performance of the semiconductor device.

Analogously to what is described for the methods 100, 200, the information on the compliance policy may comprise a list of predetermined performance thresholds (e.g. be allowable performance limits) associated with the semiconductor devices (e.g. a performance threshold list). The processor 420 may receive the predetermined performance threshold associated with the semiconductor device and send a signal, data, or information to the semiconductor device to throttle its performance according to its allowable performance limit analogously to what is described for the methods 100, 200.

For example, the circuitry 400 may optionally comprise a device 430 to receive information about the location of the circuitry 400. The device 440 may be a GNSS tracker analogously to what is described for the method 100. The device 400 may be built into the processor 420 or connected to the processor 420 via the interface as described above or via an electrical pathway. The location information received via the device 430 may be combined with another location information of the circuitry 400 to improve transparency and accuracy of the location information of the circuitry 400 analogously to what is described for the method 100.

For instance, the performance of the semiconductor device 430 may be monitored regularly (e.g. predetermined time interval) based on its power consumption information analogously to what is described for the methods 100, 200. The interface may monitor connected devices (e.g. the semiconductor device) and generate telemetry data (e.g. power consumption of the semiconductor device) or trigger a generation of the telemetry data, which may be sent to the processor 410. The telemetry data is as described for the method 100, 200. If the telemetry data does not match with an expected performance of the semiconductor device, the processor 420 may throttle the performance of the semiconductor device 430 analogously to what is described for the methods 100, 200. For example, the telemetry data may indicate that the semiconductor device consumes higher power than the expected power consumption based on its allowable performance limit according to the information on the compliance policy. Then, the processor 420 throttle (reduce) the power supply to the semiconductor device via the interface accordingly. Analogously to what is described for the method 100, the processor may further be configured to verify a security certificate of the (associated) semiconductor device or generate an audit log.

Therefore, the circuitry 400 may provide a way to throttle the performance of the associated semiconductor device without replacing it in accordance with the compliance policy. It may also reduce cost and time to produce various semiconductor devices with different specifications to meet regulatory requirements.

FIG. 5 illustrates an example of a computer system 500 for performance management. The computer system 500 comprises a storage medium 510 configured to store information on a compliance policy. The information on the compliance policy comprises a list of countries (a country list) and a list of semiconductor devices (a device list). The computer system 500 further comprises at least one device 520 to receive information to determine a location of the computer system 500. The computer system 500 further comprises a semiconductor device 530. Additionally, the computer system 500 comprises a processor 540 configured to determine the location of the computer system and to throttle a performance of the semiconductor device 530 based on the information on the compliance policy if the semiconductor device 530 is within the list of semiconductor devices and if the location of the computer system 500 matches with a country within the list of countries. The compliance policy and the information on the compliance policy are as described for the methods 100, 200. Additionally, throttling may be performed analogously to what is described above for the methods 100, 200.

The computer system 500 may provide a way to manage the performance of the semiconductor device 530 comprised in the computer system 500 based on the location of the computer system 500. Hence, when the computer system 500 is located in a country on the list of countries, a user may not need to use a customized semiconductor device (e.g. low-performance) in accordance with the compliance policy.

More details and aspects are mentioned in connection with the embodiments described above or below. The example shown in FIG. 5 may comprise one or more optional additional features corresponding to one or more aspects mentioned in connection with the proposed concept or one or more examples described above (e.g. FIGS. 1-4).

For example, the storage medium 510 may be connected to the processor 540 via an electrical pathway, a trace, or an interface, which enables communication between the storage medium 510 and the processor 530. The interface is as described for the method 100 or the circuitry 400. Similarly, the semiconductor device 530 and the processor 540 may be connected as described above for the storage medium 510. The at least one device 520 may be analogous to what is described for the circuitry 400. For example, the at least one device 520 may be a GNSS tracker. The at least one device 520 may be connected to the processor 540 via an electrical pathway, a trace, or be built into the processor 540 or the semiconductor device 530. Analogously to what is described above for the method 100, if the at least one device 520 is built into the semiconductor device 530, the location of the semiconductor device 530 may be used as the location of the computer device.

The information on the compliance policy is as described for the method 100, 200. For example, the information on the compliance policy may be stored in the storage medium 410 such that the semiconductor device (e.g. name or identifier of the semiconductor device) and the location of the host platform (e.g. country) can be searched in or compared to the device list and the country list analogously to what is described above for the circuitry 400.

The processor 540 may determine the location (e.g. a country) of the computer system 500 based on the information received via the at least one device 520. The processor 540 may trigger or execute comparisons of the location of the computer system 500 to the country list and the semiconductor device 530 to the device list within the information on the compliance policy analogously to what is described for the circuitry 400. if the determined location of the computer system 500 and the semiconductor device 530 match with the information on the compliance policy, the processor 540 may throttle the performance of the semiconductor device 530 analogously to what is described for the circuitry 400 or the methods 100, 200.

Analogously to what is described for the methods 100, 200, the information on the compliance policy may comprise a list of predetermined performance thresholds (e.g. be allowable performance limits) associated with the semiconductor devices (e.g. a performance threshold list). Then the processor 540 may throttle the performance of the semiconductor device 530 in accordance with the allowable performance limit associated with the semiconductor device 530 analogously to what is described for the method 100,200, or the circuitry 400.

The performance of the semiconductor device may be monitored regularly (e.g. predetermined time interval) based on its power consumption information as described for the method 100, 200, or the circuitry 400. The interface may monitor connected devices (e.g. the semiconductor device) and generate telemetry data (e.g. power consumption of the semiconductor device) or trigger a generation of the telemetry data, which may be sent to the processor 540. The telemetry data is as described for the method 100, 200. If the telemetry data does not match with an expected performance of the semiconductor device 530, the processor 540 may throttle the performance of the semiconductor device 430 analogously to what is described for the methods 100, 200 or for the circuitry 400. For example, the telemetry data may indicate that the semiconductor device consumes higher power than the expected power consumption based on its allowable performance limit according to the information on the compliance policy. Then, the processor 540 throttle (reduce) the power supply to the semiconductor device via the interface accordingly. Analogously to what is described for the method 100, the processor may further be configured to verify a security certificate of the (associated) semiconductor device or generate an audit log.

The computer system 500 may further comprise at least one sensor 550 to monitor a power consumption of the semiconductor device 530 regularly (e.g. predetermined time interval) by, e.g. measuring voltage, current or power supplied to the semiconductor device 530. For example, the at least one sensor 550 may be built into the semiconductor device 530 or connected to the semiconductor device 530 via an electrical pathway. The measure data may be sent to the interface so as to be comprised in the telemetry data or may be sent to the processor 540. The at least one sensor 500 may improve accuracy and reliability of monitoring the performance of the semiconductor device 530 in addition to the interface.

Therefore, analogously to the circuitry 400, the computer system 500 may provide a way to manage the performance of the semiconductor device 530 in accordance with the compliance policy. It may enable to use high-performance semiconductor devices, which might not be viable depending on the location of the computer system 500 due to the compliance policy. Furthermore, it may reduce cost and time to produce various semiconductor devices with different specifications to meet regulatory requirements by throttling the performance of the associated semiconductor device based on the location of the computer system 500. Moreover, if the compliance policy changes, the computer system 500 may recertify, liberalize, or throttle the performance of the semiconductor device accordingly without replacing it.

In the following, some examples of the proposed concept are presented:

An example (e.g., example 1) relates to a method for performance management, the method comprising receiving information to determine a location of a host platform, receiving information on a compliance policy comprising a list of countries and a list of semiconductor devices, and throttling a performance of a semiconductor device associated with the host platform based on the information on the compliance policy if the semiconductor device is within the list of semiconductor devices and if the location of the host plat-form matches with a country within the list of the countries.

Another example (e.g., example 2) relates to a previous example (e.g., example 1) or to any other example, further comprising that the information on the compliance policy further comprises a list of predetermined performance thresholds associated with the semi-conductor devices.

Another example (e.g., example 3) relates to a previous example (e.g., one of the examples 1 or 2) or to any other example, further comprising verifying a security certificate of the semiconductor device associated with the host platform.

Another example (e.g., example 4) relates to a previous example (e.g., example 3) or to any other example, further comprising throttling the performance of the semi-conductor device if the security certificate is invalid.

Another example (e.g., example 5) relates to a previous example (e.g., example 3) or to any other example, further comprising evaluating the performance of the semiconductor device if the security certificate is valid, and throttling the performance of the semiconductor device if the evaluation does not match with the information on compliance policy.

Another example (e.g., example 6) relates to a previous example (e.g., one of the examples to 5) or to any other example, further comprising receiving telemetry data of the host platform.

Another example (e.g., example 7) relates to a previous example (e.g., example 6) or to any other example, further comprising that the telemetry data comprises an energy report.

Another example (e.g., example 8) relates to a previous example (e.g., one of the examples 6 or 7) or to any other example, further comprising throttling the performance of the semiconductor device if the telemetry data does not match with the information on the compliance policy.

Another example (e.g., example 9) relates to a previous example (e.g., one of the examples 7 or 8) or to any other example, further comprising that an energy consumption of the semiconductor device is higher than an expectation based on the information on the compliance policy.

Another example (e.g., example 10) relates to 4, or 8, wherein throttling comprises at least one of limiting slot power of the semiconductor device, limiting an interface speed of the semiconductor device, or disabling the semiconductor device.

Another example (e.g., example 11) relates to a previous example (e.g., one of the examples 1 to 10) or to any other example, further comprising updating the security certificate of the semiconductor device associated with the host platform.

Another example (e.g., example 12) relates to a previous example (e.g., one of the examples 1 to 11) or to any other example, further comprising generating an audit log, wherein the audit log comprises at least one of the location of the host platform or a power us-age or an identifier of the semiconductor device associated with the host platform.

An example (e.g., example 13) relates to a method for monitoring performance management, the method comprising receiving information to determine a location of a host platform, receiving information on a compliance policy comprising a list of countries and a list of semiconductor devices, receiving telemetry data of the host platform, and throttling a performance of the semiconductor device if the location of the host platform matches with a country within the list of countries and if the telemetry da-ta does not match with an expectation based on the information on the compliance policy.

Another example (e.g., example 14) relates to a previous example (e.g., example 13) or to any other example, further comprising that the telemetry data comprises an energy report of the host platform.

Another example (e.g., example 15) relates to a previous example (e.g., one of the examples 13 or 14) or to any other example, further comprising that the mismatch between the telemetry data and the expectation is that an energy consumption of the semiconductor device is higher than the expectation based on the information on the compliance policy.

An example (e.g., example 16) relates to a circuit for performance management configured to receive information to determine a location of the circuit, receive information on a compliance policy comprising a list of countries and a list of circuits, and throttle a performance of the circuit based on the information on the compliance policy if the circuit is within the list of circuits and if the location of the circuit matches with a country within the list of countries.

Another example (e.g., example 17) relates to a previous example (e.g., example 16) or to any other example, further comprising a device to receive information about the location of the circuit.

An example (e.g., example 18) relates to a circuitry for performance management, the circuitry comprising a storage medium to storage information on a compliance policy, wherein the information on the compliance policy comprises a list of countries and a list of semiconductor devices, and a processor configured to receive information to determine a location of the circuitry, and throttle a performance of a semiconductor device associated with the circuitry based on the information on the compliance policy if the semiconductor device within the list of semiconductor devices and if the location of the circuitry matches with a country within the list of countries.

Another example (e.g., example 19) relates to a previous example (e.g., example 18) or to any other example, further comprising a device to receive information about the location of the circuitry.

An example (e.g., example 20) relates to a computer system for performance management, the system comprising a storage medium configured to store information on a compliance policy, wherein the information on the compliance policy comprises a list of countries and a list of semiconductor devices, at least one device to receive information to determine a location of the computer system, a semiconductor device, and a processor configured to determine the location of the computer system, and throttle a performance of the semiconductor device based on the information on the compliance policy if the semiconductor device is within the list of semiconductor devices and if the location of the computer system matches with a country within the list of countries.

Another example (e.g., example 21) relates to a previous example (e.g., example 20) or to any other example, further comprising at least one device to monitor a power consumption of the semiconductor device.

Another example (e.g., example 22) relates to a machine-readable medium including code, when executed, to cause a machine to perform the method of example 1. Another example (e.g., example 23) relates to a non-transitory machine-readable storage medium including program code, when executed, to cause a machine to perform the method of example 1.

Another example (e.g., example 24) relates to a computer program having a program code for performing the method of example 1 when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method for performance management, the method comprising:
receiving information to determine a location of a host platform;
receiving information on a compliance policy comprising a list of countries and a list of semiconductor devices; and
throttling a performance of a semiconductor device associated with the host platform based on the information on the compliance policy if the semiconductor device is within the list of semiconductor devices and if the location of the host platform matches with a country within the list of the countries.

2. The method of claim 1, wherein the information on the compliance policy further comprises a list of predetermined performance thresholds associated with the semiconductor devices.

3. The method of claim 1, further comprising: verifying a security certificate of the semiconductor device associated with the host platform.

4. The method of claim 3, further comprising: throttling the performance of the semi-conductor device if the security certificate is invalid.

5. The method of claim 3, further comprising:
evaluating the performance of the semiconductor device if the security certificate is valid; and
throttling the performance of the semiconductor device if the evaluation does not match with the information on compliance policy.

6. The method of claim 1, further comprising: receiving telemetry data of the host platform.

7. The method of claim 6, wherein the telemetry data comprises an energy report.

8. The method of claim 6, further comprising: throttling the performance of the semiconductor device if the telemetry data does not match with the information on the compliance policy.

9. The method of claim 7, wherein an energy consumption of the semiconductor device is higher than an expectation based on the information on the compliance policy.

10. The method of claim 1, wherein throttling comprises at least one of limiting slot power of the semiconductor device, limiting an interface speed of the semiconductor device, or disabling the semiconductor device.

11. The method of claim 1, further comprising: updating the security certificate of the semiconductor device associated with the host platform.

12. The method of claim 1, further comprising: generating an audit log, wherein the audit log comprises at least one of the location of the host platform or a power us-age or an identifier of the semiconductor device associated with the host platform.

13. A method for monitoring performance management, the method comprising:
receiving information to determine a location of a host platform;
receiving information on a compliance policy comprising a list of countries and a list of semiconductor devices;
receiving telemetry data of the host platform; and
throttling a performance of the semiconductor device if the location of the host platform matches with a country within the list of countries and if the telemetry da-ta does not match with an expectation based on the information on the compliance policy.

14. The method of claim 13, wherein the telemetry data comprises an energy report of the host platform.

15. The method of claim 13, wherein the mismatch between the telemetry data and the expectation is that an energy consumption of the semiconductor device is higher than the expectation based on the information on the compliance policy.

16. A circuitry for performance management, the circuitry comprising:
a storage medium to storage information on a compliance policy, wherein the information on the compliance policy comprises a list of countries and a list of semiconductor devices; and
a processor configured to
receive information to determine a location of the circuitry; and
throttle a performance of a semiconductor device associated with the circuitry based on the information on the compliance policy if the semiconductor device within the list of semiconductor devices and if the location of the circuitry matches with a country within the list of countries.

17. The circuitry of claim 16, further comprising: a device to receive information about the location of the circuitry.
